(19) United States
(12) Patent Application Publication
(10) Pub. No.: US 2007/0143931 A1
(43) Pub. Date: Jun. 28, 2007

(54) Method for Indicating Previous Use of a Hygienic Garment Protector

(76) Inventor: Ghisini Elena, Acquafredda (IT)

Correspondence Address: SHOEMAKER AND MATTARE, LTD, 10 POST OFFICE ROAD - SUITE 110, SILVER SPRING, MD, 20910, US

(21) Appl. No.: 11/548,112

(22) Filed: Oct. 10, 2006

Related U.S. Application Data
(62) Division of application No. 10/885,882, filed on Jul. 8, 2004, now abandoned.

(30) Foreign Application Priority Data
Feb. 13, 2004 (IT) BS2004A000016

(51) Int. Cl. C11D 3/00

(52) U.S. Cl. 8/115.51

(57) ABSTRACT

A protective garment for temporary use in the fitting room of a clothing store is placed, in an initially dry condition, in a hermetic containment wrapping. One can determine whether the protective garment has been worn by someone else and replaced in the wrapping by observing whether there is moisture on the walls of the wrapping.

This application is a division of copending application Ser. No. 10/885,882, filed Jul. 8, 2004.

### BACKGROUND OF THE INVENTION

This invention relates to a method of indicating prior use by another of a hygienic garment protector such as a temporary clothing article, such as a sock or glove, in a clothing store fitting room.

### BACKGROUND OF THE INVENTION

Generally, when one intends to buy an article of clothing, such as a pair of shoes, a pair of gloves and the like, it is useful to try on such article of clothing to prevent wrong purchases.

A particular article of clothing may actually be tried on by many customers, both because it is not bought immediately, and because the shops only use a limited number of samples for fitting to avoid ruining a large number of articles.

Such situation causes the onset of hygiene problems, which are increasingly felt by the customers, since the same shoe or the same glove is tried on by many people.

In order to cope with this situation, some shops provide a protective garment to the customers, such as a sock or a glove, to wear between the involved body part and the article to be purchased.

Since afterwards, such protective garments are left in the shop itself, the need of making them not reusable or at least making them visibly used already, is increasingly felt.

### SUMMARY OF THE INVENTION

The object of the present invention is to provide a fitting kit which includes a protective garment, for example a socket or a glove, and a wrapping adapted for containing the garment, the kit being provided with safety means indicating a previous use of the protective garment.

### BRIEF DESCRIPTION OF THE DRAWINGS

The features and advantages of the present invention will appear more clearly from the following description of a preferred embodiment, made by way of a non-limiting example, with reference to the annexed figures, wherein:

FIG. 1 shows the fitting kit wherein the previous use of the protective garment is evident, and

FIG. 2 shows the elements of the fitting kit.

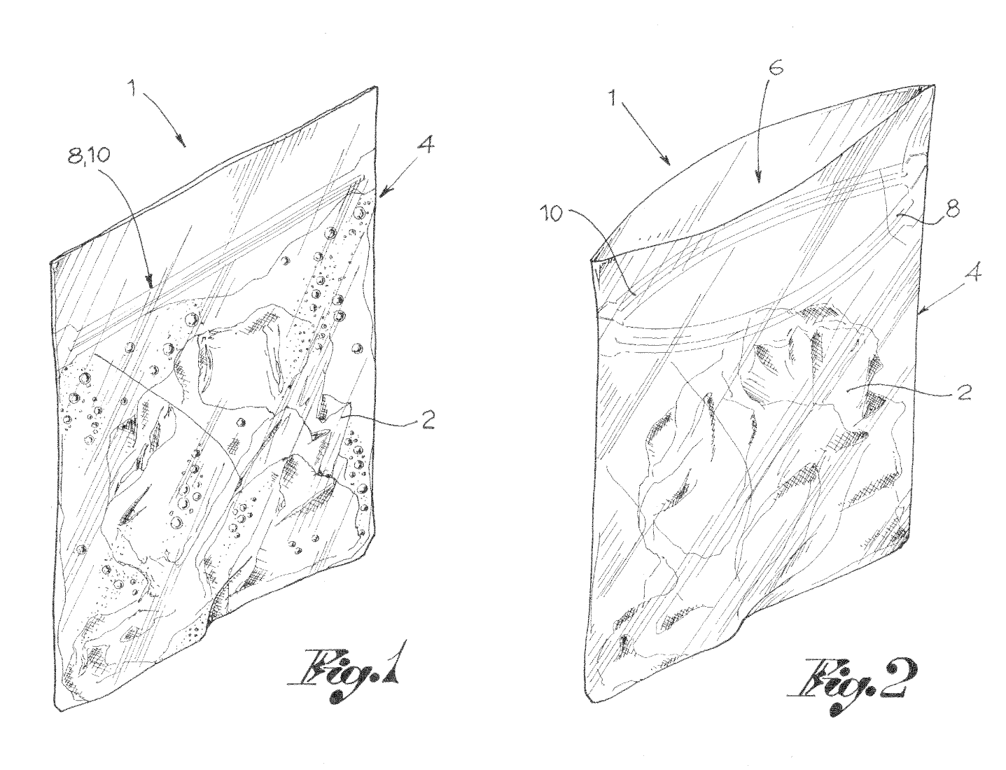

### DETAILED DESCRIPTION OF THE INVENTION

With reference to the annexed figures, reference numeral 1 globally indicates a fitting kit comprising a protective garment 2, for example a sock or a glove, adapted for being worn on a part of the body, and a wrapping 4, adapted for containing the protective garment.

Preferably, the protective garment is made of a textured and/or elastomeric fabric, for example nylon.

The wrapping 4, for example a polyethylene bag, has an opening 6 adapted for introducing and removing the protective garment 2 into/from the wrapping 4.

The wrapping 4 further comprises closing means, adapted for closing the opening 6 for containing the protective garment into wrapping 4 in a hermetic or air-tight fashion.

For example, the closing means comprise a pair of conjugated elements 8, 10 which, engaging snap-wise, close the opening 6.

The method for manufacturing the fitting kit 1, comprises a first step for manufacturing the protective garment, using a suitable manufacturing system.

For example, in the case of a protective sock, the garment is produced using a circular loom.

Afterwards, the protective garment is subject to a sanitization treatment to obtain a hygienic protective garment.

Preferably, the sanitization step of the protective garment comprises a wash of the garment in an acid bath.

Preferably, moreover, a dyeing step is performed on the protective garment, for example with a wash in a bath provided with dyeing substances.

According to a preferred embodiment of the manufacturing method, the sanitization step and the dyeing step coincide, since the protective garment is washed in an acid bath containing dyeing substances.

Afterwards, the hygienic protective garment is subject to a heating treatment to obtain a hygienic and dry garment.

The hygienic and dry garment is put into wrapping 4 through opening 6. Then, the wrapping is closed by the closing means.

In the normal use of the fitting kit, for example in a shoes shop, wrapping 4 is opened and the protective garment is removed through opening 6 of the wrapping.

The customer wears the garment on his/her foot.

Afterwards, he/she wears the article of clothing he/she is interested to try on.

In this situation, it is clear that the protective garment is between the customer's part of the body and the article to be tried on, thus avoiding direct contact between such parts.

At the end of the fitting of the article of clothing, the latter is removed. Afterwards, it is possible to remove the protective garment and put it into the wrapping.

Once the garment has been put into the wrapping, it is possible to note that a visible liquefied fluid, in particular atmospheric water vapor, lays on the wrapping walls, thus highlighting the previous use of the protective garment.

In fact, humidity that wets the wrapping walls proves that the wrapping has been opened and the protective garment has been worn.

Unusually, therefore, the fitting kit according to the invention is provided with safety means that prove a previous use of the protective garment.

Advantageously, moreover, the material with which the protective garment is made allows manufacturing thin protective garments, adapted for being worn between the article of clothing and the part of the body without altering the fitting.

A person skilled in the art will be able to make several changes and variants to the kit and to the methods described above, which are to be regarded as merely illustrative of the invention defined by the following claims.

I claim:

1. A method for indicating previous use of a hygienic protective garment, said method comprising steps of
placing said protective garment, in a dry state, in a containment wrapping,
hermetically sealing the containment wrapping, and at some later time
observing whether moisture is present on the walls of the container, said moisture indicating that the protective garment has been previously worn.

2. The method of claim 1, further comprising a step of heating the protective garment to dry it before placing it in the containment wrapping.

3. The method of claim 1, further comprising a step of sanitizing the protective garment before placing it in the containment wrapping.

4. The method of claim 3, wherein the sanitizing step comprises washing the protective garment in an acid bath.

5. The method of claim 4, wherein the acid bath comprises at least one dyeing substance.

6. A method of detecting previous use of a protective garment contained in a fitting kit comprising the protective garment, and a containment wrapping having an opening and provided with means for closing the opening for containing the protective garment in an air-tight fashion, wherein the garment, in a dry state, is sealed in the wrapping, said method comprising a step of observing whether there are drops of moisture inside the wrapping.

7. The method of claim 6, wherein the method comprises steps of, before the observing step:
opening the containment wrapping
removing the garment from the wrapping,
wearing the garment on a part of the body,
removing the garment from the part of the body, and
replacing the garment in the wrapping.
